(19) United States
(12) Patent Application Publication
(10) Pub. No.: US 2003/0079369 A1
(43) Pub. Date: May 1, 2003

(54) Process and apparatus for drying drying a thick film layer

(75) Inventors: Shalom Luski, Rehovot (IL); Nitzan Zvi, Petach Tikva (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: POWER PAPER LTD., Kibbutz Einat (IL)

(21) Appl. No.: 09/984,244

(22) Filed: Oct. 29, 2001

(51) Int. Cl. B05D 1/36; B05D 7/00; F26B 7/00; F26B 3/00

(52) U.S. Cl. 34/423; 34/445; 34/493

(57) ABSTRACT

A process of forming a thick film structure comprising depositing a layer of thick film on a supporting carrier and drying the thick film layer in a plurality of controlled stages, and an apparatus for executing the process.

### FIELD AND BACKGROUND OF THE INVENTION

The present invention relates to the field of fabricating printed circuits and, more particularly, to the drying/curing process utilized in such fabrication.

The traditional printed circuit board comprises a supporting substrate and copper foil circuit traces thereon. These traces were initially formed by the chemical etching of a pattern defined onto a laminated copper surface. The technology of printed circuits has evolved extensively and there are presently many methods known in the art to create the electrical circuit traces on a circuit board.

U.S. Pat. No. 4,602,318 describes achieving high density electronic networks by depositing filaments onto a substrate and using a high-energy beam to cut through and expose the filaments where needed.

U.S. Pat. No. 4,912,844 describes using a heated punch to define grooves and holes in a substrate and filling these grooves with solder to create circuit traces.

U.S. Pat. No. 5,371,654 describes a plurality of assemblies interconnected by an elastomeric material.

U.S. Pat. Nos. 5,646,231, 5,646,232 and 5,654,392 describe the use of rigid rod polymers to form a plastic molded circuit board.

A related technology exists known as polymer thick film in which the traces are printed on the substrate with an ink or paste containing electrically conductive particle filled polymer compositions. When fired at the correct temperatures, materials within the ink fuse or stack to form conductive traces which connect components or to which components may be affixed.

U.S. Pat. No. 5,376,403 describes a number of such ink formulations which can be used to form circuit traces, each with different electrical properties.

The benefits of such Polymer Thick Film (PTF) printed circuits are substantial and include the ability to achieve high-density circuitry without consuming board surface, ease of fabrication employing a range of compatible printing processes, and economical production.

However, the PTFs presently known in the art suffer from poor reliability and inadequate performance, as detailed in, for example, U.S. Pat. No. 5,376,403, which is incorporated herein by reference.

One of the causes of such poor reliability is the damage that results from rapidly drying the wet ink or paste. A slow drying process allows the PTF layer to harden and cure in a manner that does not impair the electrical performance of the resulting trace. However, commercial considerations require a fast drying process, which often results in reduced electrical performance for two reasons. First, fast drying typically causes an unevenly dried layer, with the surface of the layer drying earlier than the interior, causing the surface to be damaged as the layer dries completely. Second, fast drying inhibits the conductive particles within the ink or paste from aligning, stacking and/or fusing for maximum conductivity and minimum resistance.

There are presently three common fast drying methods employed in the industry for PTF applications. The first consists of creating turbulent hot air flow within the oven while flowing high speed hot air perpendicular to the wet layer. The second consists of a combination of back heating through contact with a hot surface, either a hotplate or the conveyor belt, and high speed hot air on the surface. The third is based on infra red heating where the heat is supplied by lamps or burning of gas, also with high speed hot air flowing on the surface of the wet layer.

Such methods result in a dry PTF layer free of residual solvent, but typically with the electrical impairments described earlier.

There is thus a widely recognized need for a drying process of printed PTF circuits that is rapid and that does not damage the electrical properties of the layer and the resulting trace.

### SUMMARY OF THE INVENTION

According to one aspect of the present invention there is provided a process of forming a thick film structure, such as, but not limited to, conductive tracks, conductive pads, conductive jumpers, etch resists, crossovers, heating elements, various electrodes and sensors, the process comprising depositing a layer of thick film on a supporting carrier and drying the layer of thick film in a plurality of stages, wherein a first stage of the plurality of stages comprises exposing the thick film layer to heat of a prescribed temperature and duration with minimal or no air flow, whereas subsequent stages of the plurality of stages comprise exposing the thick film to heat of a prescribed temperature and duration with simultaneous air flow.

According to a further aspect of the present invention there is provided a process of drying a thick film layer, such as, but not limited to, conductive tracks, conductive pads, conductive jumpers, etch resists, cross-overs, heating elements, various electrodes and sensors, on a supporting carrier, the process comprising exposing the thick film layer to heat of a temperature ranging between 50 degrees Centigrade and 100 degrees Centigrade for a period ranging between one minute and ten minutes, with minimal or no air flow over the surface; exposing the thick film layer to heat of a temperature ranging between 100 degrees Centigrade and 140 degrees Centigrade for a period ranging between one minute and ten minutes, with air flow over the surface; and exposing the thick film layer to heat of a temperature ranging between 120 degrees centigrade and 160 degrees Centigrade for a period ranging between one minute and ten minutes, with air flow over the surface.

According to a further aspect of the present invention there is provided an apparatus for drying a thick film structure comprising a combination of heating devices and air flow generators predesigned and preconstructed for drying the layer of thick film in a plurality of stages, wherein a first stage comprises exposing the thick film layer to heat of a prescribed temperature and duration with minimal or no air flow and subsequent stages comprise exposing the thick film to heat of a prescribed temperature and duration with simultaneous air flow.

According to further features in the described preferred embodiments drying is carried out in three stages, the temperature of each stage being higher than the temperature of the stage preceding it.

According to further features in the described preferred embodiments the temperature of the first stage ranges between 50 degrees Centigrade and 100 degrees Centigrade; the temperature of the next subsequent stage ranges between 100 degrees Centigrade and 140 degrees Centigrade; and the temperature of the next subsequent stage ranges between 120 degrees Centigrade and 160 degrees Centigrade.

According to further features in the described preferred embodiments of the invention the duration of the exposure to the heat of the first stage ranges between one and ten minutes.

According to further features in the described preferred embodiments the duration of the exposure to the heat of each stage ranges between one and ten minutes.

According to further features in the described preferred embodiments the thick film is a polymer thick film.

According to further features in the described preferred embodiments the thick film structure is electrically conductive.

According to further features in the described preferred embodiments the thick film structure is electrically insulating.

According to further features in the described preferred embodiments the supporting carrier is a substrate serving as a basis for a printed circuit.

According to further features in the described preferred embodiments the apparatus comprises a control mechanism for controlling the heating devices and the air generators; the control mechanism being preprogrammable or programmable for effecting the drying.

According to further features in the described preferred embodiments the apparatus comprises a plurality of chambers wherein a first chamber of the plurality of chambers is for producing heat of a prescribed temperature with minimal or no airflow, and subsequent chambers of the plurality of chambers are for providing heat of a prescribed temperature with simultaneous airflow.

According to further features in the described preferred embodiments the apparatus comprises three chambers wherein each chamber is capable of producing heat of a higher temperature than a chamber preceding it.

According to further features in the described preferred embodiments the first chamber is for producing heat with a temperature ranging between 50 degrees Centigrade and 100 degrees Centigrade; the next subsequent chamber is for producing heat with a temperature ranging between 100 degrees Centigrade and 140 degrees Centigrade; and the next subsequent chamber is for producing heat with a temperature ranging between 120 degrees Centigrade and 160 degrees Centigrade

According to further features in the described preferred embodiments the heat produced by each chamber is capable of being adjusted in temperature.

According to further features in the described preferred embodiments there is provided a mechanism for conveying the layer of thick film from the first chamber sequentially to each of the subsequent chambers.

According to further features in the described preferred embodiments the mechanism is further for conveying the layer of thick film through each chamber.

According to further features in the described preferred embodiments the mechanism is for conveying the layer of thick film through each chamber at an adjustable rate of speed such that the duration of time that the layer of thick film remains within each chamber is capable of being controlled.

The present invention successfully addresses the shortcomings of the presently known configurations by providing a drying process of PTF printed circuits that is fast and controllable and results in desired electrical performance.

### BRIEF DESCRIPTION OF THE DRAWINGS

With specific reference now to the drawings in detail, it is stressed that the particulars shown are by way of example and for the purposes of illustrative discussion of the preferred embodiment of the present invention only, and are presented in the cause of providing what is believed to be the most useful and readily understood description of the principles and conceptual aspects of the invention. In this regard, no attempt is made to show structural details of the invention in more detail that is necessary for a fundamental understanding of the invention, the description taken with the drawings making apparent to those skilled in the art how the several forms of the invention may be embodied in practice.

In the drawings:

FIG. 1 is a schematic representation of a drying apparatus constructed in accordance with the teachings of the present invention; and

FIG. 2 is a black box diagram representing the control mechanism of the apparatus of FIG. 1.

### DESCRIPTION OF THE PREFERRED EMBODIMENTS

The present invention is of a process and apparatus for forming thick film structures, such as, but not limited to, conductive tracks, conductive pads, conductive jumpers, etch resists, cross-overs, heating elements, various electrodes and sensors. The process and apparatus of the present invention offer advantages over existing processes and apparati in that it allows both fast drying of the thick film structures and, at the same time, causes less damage to the structure upon drying.

Before explaining at least one embodiment of the invention in detail, it is to be understood that the invention is not limited in this application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

The principles and operation of a Polymer Thick Film drying process and apparatus according to the present invention may be better understood with reference to the drawings and accompanying descriptions.

The present invention provides a process of forming a thick film structure on a supporting carrier which comprises depositing a layer of thick film on the supporting carrier and drying the layer in a plurality of stages. The first stage employs heat with minimal or no air flow and the subsequent stages employ heat in conjunction with forced air flow. According to a preferred embodiment, the thick film is an electrically conductive Polymer Thick Film (hereinafter referred to as PTF) in the form of a wet ink or paste which is deposited on a substrate which is the basis of a printed circuit board. After deposition of the PTF layer, the composition is dried and cured preferably by exposure to three stages of increasing degrees of heat, with the second and third stages applying hot air movement. The temperature, duration of exposure and method of application of the heat during drying are all significant with respect to the resultant electrical properties of the PTF structure. Accordingly, the drying is a critical element in the fabrication of circuit boards and is the subject of the present invention.

Such PTF structures fabricated according to the preferred embodiment of the present invention which serve as electrical traces on circuit boards may provide passive functions, such as resistance, capacitance or dielectric separation within the electrical circuit or may provide conductivity, connecting subassemblies containing active electronic devices and active functions such as transistors, diodes, integrated circuits, and other similar electronic devices. Such circuit traces might be conductive tracks and pads, conductive jumpers, etch resists, crossovers, heating elements, electrodes, sensors and/or serve many other applications. PTF traces provide both conductivity and connectivity to the electronic components of circuit boards.

The use of PTF circuit boards is widespread in the industry both because they are economical to produce and because of their concise construction. The process of depositing PTF compositions on a substrate also provides manufacturing advantages such as high precision printing with less tendency to bridge between traces or to form satellites and with no need for cleaning or flux removal. However, it is understood that the present invention also includes PTF structures used for purposes other than circuit boards.

According to a preferred embodiment of the invention, the PTF layer deposited on the substrate is dried in three stages which allow it to harden and cure in a manner which results in a layer having desired electrical properties. The first stage includes heating the PTF layer to a temperature ranging between 50 degrees Centigrade and 100 degrees Centigrade for a duration of between one and ten minutes with minimal or no air flow (e.g., no forced air flow) on the surface of the layer. The second stage of the drying process includes heating the PTF layer to a temperature ranging between 100 degrees Centigrade and 140 degrees Centigrade for a duration of between one and ten minutes with hot air flow on the surface of the layer. The third stage of drying includes heating the PTF layer to a temperature ranging between 120 degrees Centigrade and 160 degrees Centigrade for a duration of between one and ten minutes with hot air flow on the surface of the layer.

It is appreciated that different compositions of PTF inks and pastes will have different drying requirements in order to possess the desired electrical characteristics when fully dried. One of ordinary skills in the art, provided with the details described herein would know how to adjust the process of the present invention for PTFs of varying compositions, thickness and substrate coverage.

The drying process of a PTF layer influences the electrical characteristics of the resulting trace because it has an effect both on the surface of the trace and upon the alignment and bonding of the conductive particles comprising the resulting layer. The above described drying process result in an intact and contiguous surface layer and also an optimal conductive structure within the layer. In order to understand why this happens, it is necessary to understand the composition of the PTF layer.

There are many PTF compositions known in the art with advantageous properties, such as bulk electrical conductivity approaching that of solid copper, good solderability, adhesive strength, corrosion resistance and mechanical integrity. Generally, such electrically conductive and adhesive PTF compositions comprise a conductive material, a reactive polymer binder and/or a resin, a cross-linking agent mixture and a suitable organic solvent, blended together in the form of a wet paste or ink which is thermoplastic or thermosetting. Thermoplastic means that while the solvent is evaporated through a drying process, the dissolved polymer acts as a binder between the conductive material and the substrate. Thermosetting means that while the solvent is evaporated at a certain temperature, a reaction is induced between two dissolved polymers, the product of which acts as a binder between the conductive material and the substrate.

The conductive material typically comprises a mixture of a high melting point metal or metal alloy powder and a low melting point metal or metal alloy powder. Typically, the high melting point metal is copper, however, other metals such as silver, aluminum, gold, platinum, palladium, beryllium, rhodium, nickel, cobalt, iron, molybdenum and high-melting point alloys of these metals are often used. The low melting point metal is usually a solder. Graphite is also used as a conductive material in some conductive inks.

The resin binder functions principally to adhere the cured composition to the substrate, to provide chemical binding sites for the reaction products after curing, and to increase the cohesive strength of the cured composition. The preferred resin is epoxy resin but may be any resin which can be cross-linked by the curing agent or which may be modified to be cross-linkable. Resins which meet this requirement include, but are not limited to, epoxies, phenolics, novalacs, polyurethanes, polyimides, bismaleimides, maleimides, cyanate esters, polyvinyl alcohols, polyesters, and polyureas, acrylics, rubbers, polyamides, polyacrylates, polyethers, polysulfones, polyethylenes, polypropylenes, polysiloxanes, polyvinyl acetates/polyvinyl esters, polyolefins, cyanoacrylates, polystyrenes, and polyvinyl butirol.

The reactive polymer binder also functions to adhere the cured composition to the substrate, to provide chemical binding sites for the reaction products after curing, and to increase the cohesive strength of the cured composition. The reactive polymer may be any species, monomeric or polymeric, which may be cross-linked by the curing agent. The preferred reactive polymer contains at least one —OH group, and preferably two or more —OH groups, as reactive sites for linking with cross-linking agents and the resin. A preferred reactive polymer is bisphenol A.

The principal function of the cross-linking agent is to cure the polymer and to serve as a fluxing agent to remove oxides from the metals. Cross-linking agents known in the art include anhydrides, carboxylic acids, amides, imides, amines, alcohols/phenols, aldehydes/ketones, nitro compounds, nitrites, carbamates, isocyanates, amino acids/peptides, thiols, sulfonamides, semicarbachambers, oximes, hydrachambers, cyanohydrins, ureas, phosphoric esters/acids, thiophosphoric esters/acids, phosphonic esters/acids, phosphates and phosphonamides.

The solvent may be any of the known solvents, such as ketones, alcohols, esters, etc.

The above components, when mixed to form PTF inks and pastes, are deposited on a substrate in a low viscosity form. Such deposition can occur in a variety of ways depending on the particular composition employed, but may include screen printing, stencil printing, dispensing, electrostatic transfer, doctor blading into photoimaged or otherwise preformed patterns, or other techniques known to those skilled in the art. The thickness of the PTF composition deposited is significant with respect to the electrical properties of the resulting trace. Thicker layers containing more conductive material provide lower resistance.

The PTF composition has low viscosity because the binder element are dissolved within a solvent. During drying, the solvent evaporates, causing the composition to harden. With a slow drying process, both the surface of the layer and the interior of the layer release solvent at a uniform rate. Therefore, there is no “skin effect” caused, as is common with fast drying methods which dry the outer layer substantially faster than the interior. As a result, the solvent is able to evaporate from the interior without being restricted by a dry skin on the outer layer which inhibits the release of the solvent molecules and is damaged by such release. The fast drying methods known in the art typically employ high speed hot air flowing across the surface of the layer to reduce the air pressure and solvent vapor pressure above the layer in order to draw the solvent molecules to the surface and to drive them away. Such a process allows fast and complete drying, but results in a damaged surface. The high speed hot air flow dries the external layer rapidly, while the internal layer is still wet. As solvent molecules from the interior are drawn to escape through the surface, the dry external layer is ruptured, with either cracks or pinholes forming, thus adversely affecting the surface continuity of the layer.

In addition, this rapid and forced evaporation of the solvents inhibits the optimal alignment (e.g., stacking) of the conductive particles. In order to create an integrated conductive layer, two things must occur simultaneously. First, the binder element, which is mixed in an interpenetrating composition with the conductive material, must harden. Second, the conductive network must form. Therefore, the evaporation of the solvent, which directly effects the viscosity of the binder, must occur in coordination with the creation of the metallurgical structure which forms the conductive network.

As stated hereinbefore, the conductive material is preferably a combination of particles of a high melting point metal or alloy of metals with particles of a low melting point metal or alloy of metals, preferably solder. This mixture of conductive material forms a conductive metallurgical structure upon the application of heat sufficient to melt the low melting point metal or alloy such that it flows and binds with the particles of high melting point metal or alloy. In order for this to occur, it is essential that the low melting point metal or alloy be able to flow within the composition.

Therefore, in order for the composition to achieve maximum electrical performance, the polymer binder must maintain low viscosity up to the temperature at which the low melting point metal or alloy melts and flows. If the polymer binder becomes too thick before the low melting point metal or alloy has melted, due to the premature evaporation of solvent, it will impede the flow of the melt and reduce the degree of integration of the low melting point metal or alloy with the high melting point metal or alloy, thus reducing conductivity.

For the above two reasons, too rapid evaporation of solvent has a detrimental effect on the electrical properties of the conductive trace. It is necessary that the evaporation of solvent be uniform so that a premature skin does not form on the layer and that evaporation occur in coordination with the increase in temperature needed to melt the low melting point metal or alloy.

The process according to the present invention provides three graduated steps of increasingly higher temperatures. The initial step, which does not employ hot air flow, serves to evaporate approximately 60-70% of the solvent, both without forming a skin and leaving a composition slightly more viscous but sufficiently fluid that, when the temperature is increased in the subsequent two steps, the conductive metallurgical structure can form without being inhibited by a restrictively viscous binder elements. Accordingly, the drying process of the present invention results in a trace with an unbroken surface and with a well developed three dimensional metallurgical structure having maximum conductivity and minimum resistivity consistent with the composition and thickness of the PTF layer deposited.

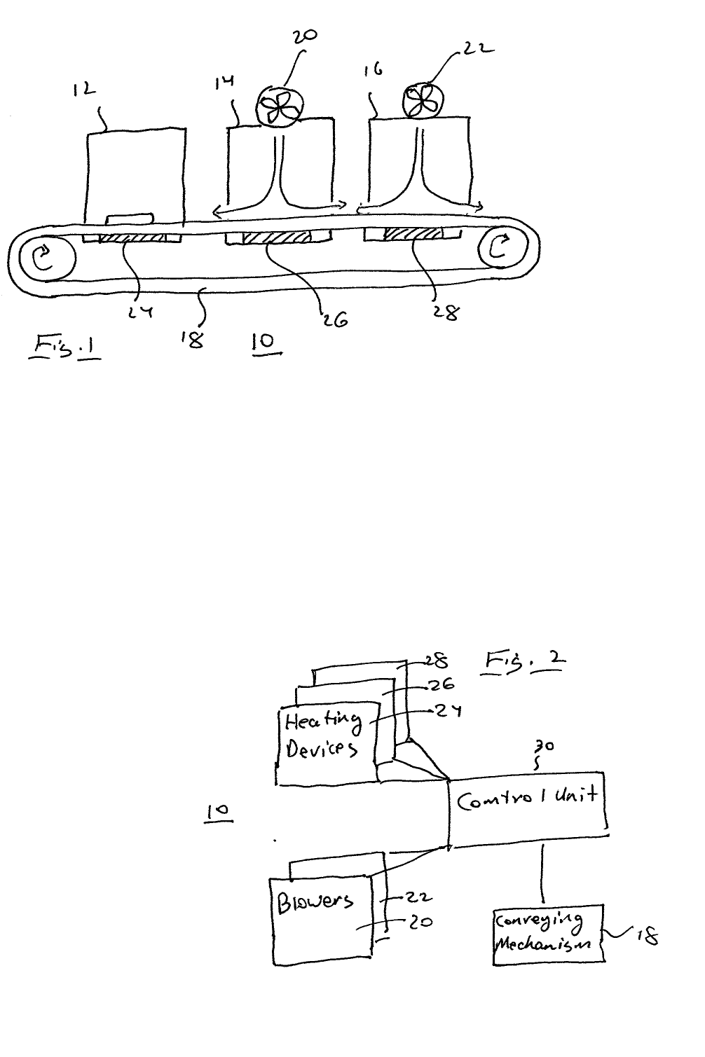

Reference is now made to FIG. 1, which is a schematic representation of an apparatus for drying a layer of PTF composition deposited on a substrate in accordance with the drying process hereinbefore described, which is hereinafter referred to as dryer 10. According to the preferred embodiment, dryer 10 comprises three distinct heating chambers, hereinafter referred to as chamber 12, chamber 14 and chamber 16 respectively, each one having the capability to produce heat of a prescribed temperature and method of application. Although dryer 10 is depicted herein in a horizontal configuration, it is understood that the chambers that constitute dryer 10 may be arranged vertically, as is known in the field as a “tower dryer”, or in any other configuration.

Chamber 12 has integral or attached thereto a heating device, hereinafter heater 24, with the capability to produce heat within chamber 12 with a temperature ranging between 50 degrees Centigrade and 100 degrees Centigrade. Chamber 14 has integral or attached thereto a heating device, hereinafter heater 26, with the capability to produce heat within chamber 14 with a temperature ranging between 100 degrees Centigrade and 140 degrees Centigrade. Chamber 16 has integral or attached thereto a heating device, hereinafter heater 28, with the capability to produce heat within chamber 16 with a temperature ranging between 120 degrees Centigrade and 160 degrees Centigrade. According to the preferred embodiment, heaters 24, 26 and 28 provide back heating to the substrate on which the PTF layer is deposited. Such a form of heating is preferred because it causes the evaporation of solvent from the base of the PTF layer first, moving through the layer toward the surface and is, therefore, least likely to form a skin on the surface of the layer. It will be appreciated that heaters 24, 26 and 28 may utilize any method of heat generation that current or future technology provides, including but not limited to electric coil, gas combustion, infrared or heat lamp. The present invention contemplates all methods of creating heat and all methods of subjecting a PTF layer to the described temperature within the respective chamber.

In addition, chamber 14 and chamber 16 each have, either integral or attached thereto, a mechanism capable of generating a continuous stream of air, preferably hot air, respectively designated and hereinafter referred to as blower 20 and blower 22, which is capable of directing a stream of hot air upon the surface of a PTF layer deposited upon a substrate located within its respective chamber. The present invention contemplates all methods of generating the required air stream, including but not limited to a motor driven turbine, a compressor creating compressed air, releasing compressed air from a container, or a mechanism creating turbulence within the chamber.

It will be appreciated that dryer 10 may be designed and configured to dry PTF layers of different thicknesses and composed of different materials, therefore having different resulting electrical properties. Accordingly, chambers 12, 14 and 16 will be capable of adjustment by a user to provide heat of different temperatures as the requirements of the relevant PTF layer will dictate. Moreover, chambers 14 and 16 may preferably have varying capabilities to provide airflow as the requirements of the relevant PTF layer will dictate. Further, dryer 10 may preferably comprise more or less chambers, as the specific requirements of the relevant PTF layer will dictate. The present invention contemplates all such combinations, temperatures, heat applications, air movements and any combinations thereof, provided that one chamber of dryer 10 provides heat with minimal or no air flow and the remaining chambers provide heat with air flow.

The drying process described requires the exposure of a PTF layer to three stages of heat, which are, according to the preferred embodiment, produced within a chamber of dryer 10. Accordingly, the preferred embodiment of dryer 10 will preferably include a conveyancing mechanism, such as a conveyor belt 18, which will carry a PTF layer on a substrate into, through and out of chamber 12; into, through and out of chamber 14, and into, through and out of chamber 16. The rate of speed of conveyor belt 18 will preferably be adjustable such that the period of time that the PTF layer is exposed to the heat within each of chambers 12, 14 and 16 is controllable by a user. It will be appreciated that the conveyancing mechanism employed is not necessarily limited to conveyor belt 18, but may consist of any device (e.g., robotic arm) capable of transporting the substrate upon which a PTF layer is deposited into and through the respective chambers of device 10.

Reference is now made to FIG. 2. Device 10 further comprises a control mechanism, hereinafter control unit 30, capable of being programmed or preprogrammed to effect the desired drying process by controlling heating devices 24, 26 and 28 and blowers 20 and 22 and conveyancing mechanism 18 of dryer 10. Control unit 30 enables a user to vary each of the functions and to program for execution a drying process appropriate to the composition and thickness of the relevant PTF layer and in accordance with the electrical properties sought. Specifically, control unit 30 can govern the temperature produced by the heating devices; the temperature, volume, velocity and direction of air produced by the blowers; and the rate of speed and mode of action (continuous, stepwise) of the conveyancing mechanism. Control unit 30 can preferably be programmed for executing any combination of the above elements.

Control unit 30 may be integral to dryer 10 or removably attachable thereto. It may further be configured to be a remote control device, having the capability to communicate with the above listed elements of dryer 10 either by hardwire or wirelessly, using infrared, radio or other means of wireless communications.

The present invention is not limited to any one design or configuration, but preferably includes all devices that are capable of exposing a PTF layer to the hereinbefore described heat and air flow requirements. Such devices preferably include, but are not limited to, a structurally fixed base comprising a plurality of chambers which provide the required heat and airflow along with a conveyor means that moves a PTF layer from chamber to chamber as required, a heated conveyor with a controllable temperature that is passed through chambers that provide the required air flow, or an apparatus with a single chamber that is capable of adjustment to provide the sequential stages of heat and airflow as required. The present invention contemplates all such devices.

The preferred embodiment of the present invention relates specifically to the fabrication of electronic circuit boards. Therefore, the present invention contemplates, but is not limited to, all of the above described variations of PTF and substrate materials and technology used in the fabrication of circuit boards. However, it will be appreciated that PTF technology is used in other industries and applications and therefore the electrical properties of any electric or electronic device manufactured using PTF technology will be influenced by the drying of the PTF layer during the fabrication process. Accordingly, the present invention contemplates all applications of PTF technology in the manufacturing of any device in which the process includes the drying of a PTF composition layer.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable subcombination.

It will be appreciated by persons skilled in the art that the present invention is not limited to what has been particularly shown and described hereinabove. Rather, the scope of the present invention is defined by the appended claims and includes both combinations and subcombinations of the various features described hereinabove as well as variations and modifications thereof which would occur to persons skilled in the art upon reading the foregoing description. Accordingly, it is intended to embrace all such alternatives, modifications and variations that fall within the spirit and broad scope of the appended claims.

What is claimed is:

1. A process of forming a thick film structure on a supporting carrier comprising depositing a layer of thick film on said supporting carrier and drying said layer of thick film in a plurality of stages, wherein a first stage of said plurality of stages comprises exposing said thick film layer to heat of a prescribed temperature and duration with minimal or no air flow, whereas subsequent stages of said plurality of stages comprise exposing said thick film to heat of a prescribed temperature and duration with simultaneous air flow.

2. The process of claim 1, wherein said drying is carried out in three stages and wherein the temperature of each of said stages is higher than the temperature of a stage preceding it.

3. The process of claim 1, wherein the temperature of said first stage ranges between 50 degrees Centigrade and 100 degrees Centigrade; the temperature of the next subsequent stage ranges between 100 degrees Centigrade and 140 degrees Centigrade; and the temperature of the next subsequent stage ranges between 120 degrees Centigrade and 160 degrees Centigrade.

4. The process of claim 1, wherein the duration of the exposure to the heat of said first stage ranges between one and ten minutes.

5. The process of claim 1, wherein the duration of the exposure to the heat of each of said stages ranges between one and ten minutes.

6. The process of claim 1, wherein said thick film is a polymer thick film.

7. The process of claim 1, wherein said thick film structure is electrically conductive.

8. The process of claim 1, wherein said supporting carrier is a substrate serving as a basis for a printed circuit.

9. A process of drying a thick film layer on a supporting carrier comprising:
(a) exposing said thick film layer to heat of a temperature ranging between 50 degrees Centigrade and 100 degrees Centigrade for a period ranging between one minute and ten minutes, with minimal or no air flow over a surface of said thick film layer;
(b) exposing said thick film layer to heat of a temperature ranging between 100 degrees Centigrade and 140 degrees Centigrade for a period ranging between one minute and ten minutes, with air flow over the surface of said thick film layer; and
(c) exposing said thick film layer to heat of a temperature ranging between 120 degrees centigrade and 160 degrees Centigrade for a period ranging between one minute and ten minutes, with air flow over the surface of said thick film layer.

10. The process of claim 9, wherein said thick film is a polymer thick film.

11. The process of claim 9, wherein said thick film layer is electrically conductive.

12. The process of claim 9, wherein said supporting carrier is a substrate serving as a basis for a printed circuit.

13. An apparatus for drying a thick film structure comprising a mechanism including at least one heating device and at least one air generator designed and constructed for drying said layer of thick film in a plurality of stages, wherein a first stage of said plurality of stages comprises exposing said thick film layer to heat of a prescribed temperature and duration with minimal or no air flow and subsequent stages of said plurality of stages comprise exposing said thick film to heat of a prescribed temperature and duration with simultaneous air flow.

14. The apparatus of claim 13, further comprising a control mechanism for controlling said at least one heating device and at least one air generator; said control mechanism being preprogrammable or programmable for effecting said drying.

15. The apparatus of claim 13, comprising a plurality of chambers wherein a first chamber of said plurality of chambers is for producing heat of a prescribed temperature with minimal or no airflow, and subsequent chambers of said plurality of chambers are for providing heat of a prescribed temperature with simultaneous airflow.

16. The apparatus of claim 15, comprising three chambers wherein each chamber is for producing heat of a higher temperature than a chamber preceding it.

17. The apparatus of claim 15, wherein said first chamber of said plurality of chambers is for producing heat with a temperature ranging between 50 degrees Centigrade and 100 degrees Centigrade; the next subsequent chamber of said plurality of chambers is for producing heat with a temperature ranging between 100 degrees Centigrade and 140 degrees Centigrade; and the next subsequent chamber of said plurality of chambers is for producing heat with a temperature ranging between 120 degrees Centigrade and 160 degrees Centigrade

18. The apparatus of claim 13, wherein the heat produced by each chamber of said plurality of chambers is capable of being adjusted in temperature.

19. The apparatus of claim 13, further comprising a mechanism for conveying said layer of thick film from said first chamber of said plurality of chambers sequentially to each of the subsequent chambers of said plurality of chambers.

20. The apparatus of claim 19, wherein said mechanism is further for conveying said layer of thick film through each chamber of said plurality of chambers.

21. The apparatus of claim 20, wherein said mechanism is for conveying said layer of thick film through each chamber of said plurality of chambers at an adjustable rate of speed such that the duration of time that said layer of thick film remains within each of said chambers is capable of being controlled.
